(19) United States
(12) Patent Application Publication
(10) Pub. No.: US 2019/0297528 A1
(43) Pub. Date: Sep. 26, 2019

(54) RADIO FREQUENCY TRANSMISSION SYSTEM AND METHOD

(71) Applicant: Mars Semiconductor Corp, Hsinchu (TW)

(72) Inventor: Ming-Liang CHUNG, Hsinchu (TW)

(73) Assignee: Mars Semiconductor Corp, Hsinchu (TW)

(21) Appl. No.: 15/928,255

(22) Filed: Mar. 22, 2018

(51) Int. Cl. H04W 28/04

(52) U.S. Cl. CPC H04W 28/04

(57) ABSTRACT

A radio frequency transmission system and a radio frequency transmission method are provided. The radio frequency transmission system includes a main control unit and a plurality of transmission units. The frequency transmission method includes the steps of: a plurality of transmission units being connected to a main control network of a main control unit, respectively; when any one of the transmission units transmits data to the main control unit through radio frequency, the other transmission units in a transmittable range receiving the data simultaneously; when a data transmission of the transmission unit in the previous step fails, the data transmission being restarted by the original transmission unit or the data transmission being performed by another one of the transmission units. Thereby, the retransmission efficiency of packet loss can be enhanced and the transmission efficiency of radio frequency can be improved.

### FIELD OF THE INVENTION

The present invention relates to a wireless communication technology, and more particularly, to a radio frequency transmission system and a radio frequency transmission method, having high transmission efficiency and improving the retransmission efficiency of packet loss.

### BACKGROUND OF THE INVENTION

Nowadays, wireless communication has reached a quite high level both in technology and application, and is now widely used in radio, smart phones, personal digital assistants, wireless networks, global positioning systems, remote controls, wireless 3C products, etc. The basic concept is that multiple communication nodes can perform a long-distance transmission, without a physical connection.

Regarding the wireless communication technology, packet radio has been developed. Packet radio is a form of packet switching technology used to transmit digital data via wireless communications. Packet radio uses the same concepts of data transmission using datagrams that are fundamental to communications on the Internet. Packet radio can be used over long distances without the need for a physical connection between stations. Packet radio is a great leap forward for the wireless communication technology.

However, packet radio has its shortcomings in actual operation. The most common one is that once a packet is lost during transmission, the transmission of data will be incomplete. In the worst case, the overall transmission may be lost. Accordingly, the inventor of the present invention has devoted himself based on his many years of practical experiences to solve these problems.

### SUMMARY OF THE INVENTION

The primary object of the present invention is to establish a complete wireless communication mechanism to make the transmission between a main control unit and communication units more efficient and to improve the retransmission efficiency of packet loss during transmission.

According to one aspect of the present invention, a radio frequency transmission system is provided. The radio frequency transmission system comprises a main control unit and a plurality of transmission units. The main control unit has a main control network. The transmission units are connected to the main control network, respectively, and are capable of transmitting data to the main control unit through radio frequency. Wherein, the transmission units can transmit signals to each other. When a data transmission between any one of the transmission units and the main control unit fails, the data transmission is restarted by the original transmission unit or the data transmission is performed by another one of the transmission units.

According to another aspect of the present invention, a radio frequency transmission method is provided. The frequency transmission method comprises the steps of: a plurality of transmission units being connected to a main control network of a main control unit, respectively; when any one of the transmission units transmits data to the main control unit through radio frequency, the other transmission units in a transmittable range receiving the data simultaneously; when a data transmission of the transmission unit in the previous step fails, the data transmission being restarted by the original transmission unit or the data transmission being performed by another one of the transmission units.

Preferably, the data transmission between the transmission units and the main control unit is a bidirectional data transmission.

Preferably, when the data transmission of any one of the transmission units fails, the main control unit notifies the transmission units individually and learns signal strength after the transmission units receive a notification.

Preferably, the time for the data transmission between the transmission units and the main control unit is controlled by the main control unit.

Preferably, only one of the transmission units transmits data to the main control unit at the same time.

Accordingly, the radio frequency transmission system and the radio frequency transmission method of the present invention can enhance the retransmission efficiency of packet loss and further improve the transmission efficiency of radio frequency.

### BRIEF DESCRIPTION OF THE DRAWINGS

FIG. 1 is an architecture diagram of the system of the present invention; and

FIG. 2 illustrates the flow chart of the present invention.

### DETAILED DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

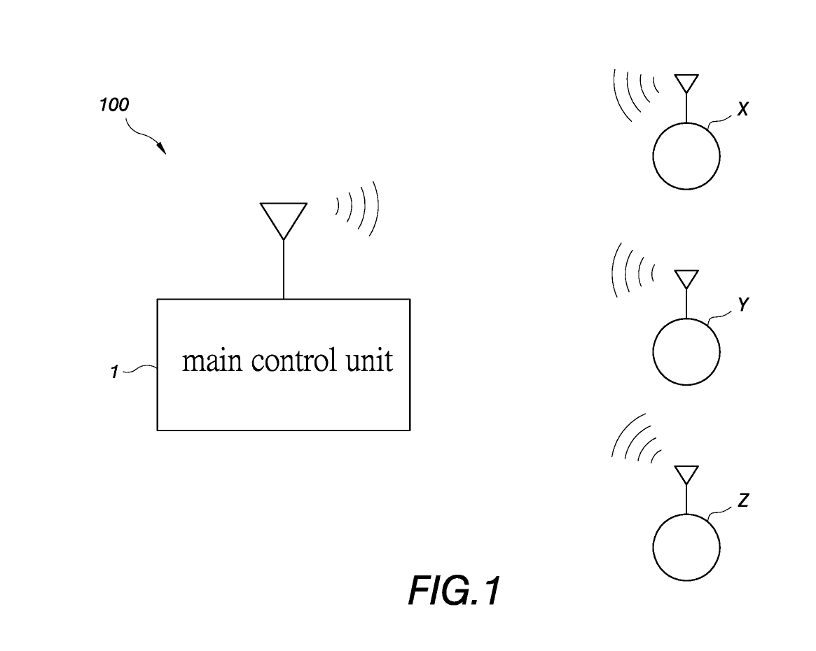

FIG. 1 is an architecture diagram of the system of the present invention. A radio frequency transmission system 100 according to the present invention comprises a main control unit 1, a first transmission unit X, a second transmission unit Y, and a third transmission unit Z. The main control unit 1 has a main control network. The first transmission unit X, the second transmission unit Y and the third transmission unit Z are connected to the main control network respectively and are capable of transmitting data to the main control unit 1 through radio frequency. In addition, the first transmission unit X, the second transmission unit Y and the third transmission unit Z can transmit signals to each other. When the data transmission between any one of the transmission units and the main control unit 1 fails, the data transmission is restarted by the original transmission unit or the data transmission is performed by another one of the transmission units.

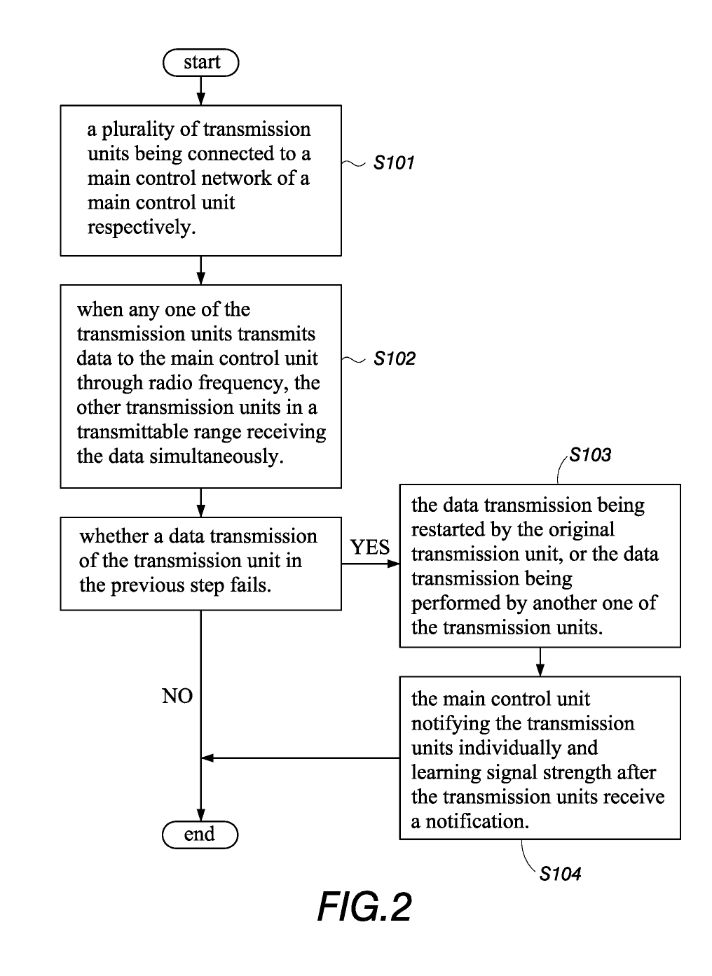

Please refer to FIG. 1 and FIG. 2. FIG. 2 illustrates the flow chart of the present invention. In the preferred embodiment of the present invention, it is assumed that the order of the connection of the transmission units and the main control unit 1 is the first transmission unit X first, the second transmission unit Y second, the third transmission unit Z last. The first transmission unit X, the second transmission unit Y and the third transmission unit Z can transmit signals with each other. In addition, the error rate of the packet transmission between the second transmission unit Y and the main control unit 1 is higher than the error rate of the packet transmission between the first transmission unit X and the main control unit 1.

As shown in step S101, the first transmission unit X, the second transmission unit Y and the third transmission unit Z are connected to the main control network of the main control unit 1, respectively. As shown in step S102, when any one of the first transmission unit X, the second transmission unit Y and the third transmission unit Z transmits data to the main control unit 1 through radio frequency, the other transmission units in the transmittable range receive the data simultaneously. As shown in step S103, when the data transmission of the transmission unit in step S102 fails, the data transmission is restarted by the original transmission unit or the data transmission is performed by another one of the transmission units. For example, when the data transmission of the second transmission unit Y fails, the data transmission may be restarted by the second transmission unit Y itself or the data transmission may be performed by the first transmission unit X or the third transmission unit Z. In this way, during the packet transmission, in the event of a loss, it can be repaired immediately, not having a fatal impact on the overall wireless transmission efficiency.

As described above, finally, as shown in step S104, when the first transmission unit X, the second transmission unit Y and the third transmission unit Z fail to transmit data, the main control unit 1 notifies the first transmission unit X, the second transmission unit Y or the third transmission unit Z individually and learns the signal strength through a received signal strength indicator (RSSI) after the first transmission unit X, the second transmission unit Y or the third transmission unit Z receives the notification.

In the preferred embodiment of the present invention, the time for the bidirectional data transmission between the first transmission unit X, the second transmission unit Y and the third transmission unit Z and the main control unit 1 can be completely controlled by the main control unit 1. Only one of the transmission units transmits data to the main control unit 1 at the same time. In other words, only one of the first transmission unit X, the second transmission unit Y and the third transmission unit Z transmits a radio frequency signal at the same time. The purpose is to avoid the collision between radio frequencies during transmission, so that the accuracy of the radio frequency transmission and the transmission efficiency can be improved greatly. To sum up, the radio frequency transmission system and the radio frequency transmission system method of the present invention can enhance the retransmission efficiency of packet loss and further improve the transmission efficiency of radio frequency.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A radio frequency transmission system, comprising:
a main control unit, having a main control network;
a plurality of transmission units, connected to the main control network respectively, the transmission units being capable of transmitting data to the main control unit through radio frequency;
wherein the transmission units can transmit signals to each other, when a data transmission between any one of the transmission units and the main control unit fails, the data transmission is restarted by the original transmission unit or the data transmission is performed by another one of the transmission units.

2. The radio frequency transmission system as claimed in claim 1, wherein the data transmission between the transmission units and the main control unit is a bidirectional data transmission.

3. The radio frequency transmission system as claimed in claim 1, wherein when the data transmission of any one of the transmission units fails, the main control unit notifies the transmission units individually and learns signal strength after the transmission units receive a notification.

4. The radio frequency transmission system as claimed in claim 1, wherein the time for the data transmission between the transmission units and the main control unit is controlled by the main control unit.

5. The radio frequency transmission system as claimed in claim 1, wherein only one of the transmission units transmits data to the main control unit at the same time.

6. A radio frequency transmission method, comprising the steps of:
(A) a plurality of transmission units being connected to a main control network of a main control unit, respectively;
(B) when any one of the transmission units transmits data to the main control unit through radio frequency, the other transmission units in a transmittable range receiving the data simultaneously;
(C) when a data transmission of the transmission unit in the step (B) fails, the data transmission being restarted by the original transmission unit or the data transmission being performed by another one of the transmission units.

7. The radio frequency transmission method as claimed in claim 6, wherein the data transmission between the transmission units and the main control unit is a bidirectional data transmission.

8. The radio frequency transmission method as claimed in claim 6, wherein when the data transmission of the transmission units fails, the main control unit notifies the transmission units individually and learns signal strength after the transmission units receive a notification.

9. The radio frequency transmission method as claimed in claim 6, wherein the time for the data transmission between the transmission units and the main control unit is controlled by the main control unit.

10. The radio frequency transmission method as claimed in claim 6, wherein only one of the transmission units transmits data to the main control unit at the same time.
